(19) United States
(12) Patent Application Publication
(10) Pub. No.: US 2015/0139547 A1
(43) Pub. Date: May 21, 2015

(54) FEATURE CALCULATION DEVICE AND METHOD AND COMPUTER PROGRAM PRODUCT

(71) Applicant: Kabushiki Kaisha Toshiba, Tokyo (JP)

(72) Inventors: Yuto YAMAJI, Kawasaki Kanagawa (JP); Tomoyuki SHIBATA, Kawasaki Kanagawa (JP); Yojiro TONOUCHI, Inagi Tokyo (JP); Isao MIHARA, Shinagawa Tokyo (JP)

(21) Appl. No.: 14/546,930

(22) Filed: Nov. 18, 2014

(30) Foreign Application Priority Data
Nov. 20, 2013 (JP) 2013-240278

(51) Int. Cl. G06K 9/00; G06K 9/46

(52) U.S. Cl. CPC G06K 9/00865; G06K 9/46
USPC 382/186

(57) ABSTRACT

According to an embodiment, a feature calculation device includes a procurement controller, a first calculator, an extraction controller, a second calculator, and an integrating controller. The procurement controller obtains a plurality of strokes. The first calculator calculates, for each of the plurality of strokes, a stroke feature quantity related to a feature of the stroke. The extraction controller extracts, for each of the plurality of strokes, from the plurality of strokes, one or more neighboring strokes. The second calculator calculates, for each of the plurality of strokes, a combinational feature quantity based on a combination of the stroke and the one or more neighboring strokes. The integrating controller generates, for each of the plurality of strokes, an integrated feature quantity by integrating the stroke feature quantity and the combinational feature quantity.

### CROSS-REFERENCE TO RELATED APPLICATIONS

This application is based upon and claims the benefit of priority from Japanese Patent Application No. 2013-240278, filed on Nov. 20, 2013; the entire contents of which are incorporated herein by reference.

### FIELD

Embodiments described herein relate generally to a feature calculation device and method, and a computer program product.

### BACKGROUND

It is a known technology in which a set of strokes that are sequentially input as handwriting by a user are subjected to structuring in terms of spatial or temporal cohesiveness; and, at each structural unit obtained as a result of structuring, the class to which the strokes attributed to the structure belong is identified (for example, it is identified whether a stroke represents a character stroke constituting characters or represents a non-character stroke constituting non-characters such as graphic forms).

However, in the conventional technology mentioned above, in order to identify the class to which a stroke belongs, it is not the features that are peculiar to the stroke under consideration which are used. Instead, it is the features of the structure to which the stroke under consideration is attributed which are used.

### BRIEF DESCRIPTION OF THE DRAWINGS

FIG. 1 is a configuration diagram illustrating an example of a feature calculation device according to a first embodiment;

FIG. 2 is an explanatory diagram illustrating an example of a stroke feature quantity according to the first embodiment;

FIG. 3 is an explanatory diagram illustrating an example of a direction density histogram of strokes according to the first embodiment;

FIG. 4 is an explanatory diagram illustrating an example of a window-based stroke extraction method according to the first embodiment;

FIG. 5 is an explanatory diagram illustrating an example of a window-based stroke extraction method according to the first embodiment;

FIG. 6 is an explanatory diagram illustrating an example of the shape and the size of a window according to the first embodiment;

FIG. 7 is an explanatory diagram illustrating an example of the shape and the size of a window according to the first embodiment;

FIG. 8 is an explanatory diagram illustrating an example of the shape and the size of a window according to the first embodiment;

FIG. 9 is an explanatory diagram illustrating an example of the shape and the size of a window according to the first embodiment;

FIG. 10 is an are explanatory diagram illustrating an example of a filtering method according to the first embodiment;

FIG. 11 is an are explanatory diagram illustrating an example of a filtering method according to the first embodiment;

FIG. 12 is an explanatory diagram illustrating an example of a calculation method for calculating the degrees of shape similarity according to the first embodiment;

FIG. 13 is an explanatory diagram illustrating an example of a calculation method for calculating the degrees of shape similarity according to the first embodiment;

FIG. 14 is an explanatory diagram illustrating an example of a specific value according to the first embodiment;

FIG. 15 is a flowchart for explaining an example of an identification operation performed according to the first embodiment;

FIG. 16 is a configuration diagram illustrating an example of a feature calculation device according to a second embodiment;

FIG. 17 is a flowchart for explaining an example of a learning operation performed according to the second embodiment;

FIG. 18 is a configuration diagram illustrating an example of a feature calculation device according to a third embodiment;

FIG. 19 is a configuration diagram illustrating an example of a feature calculation device according to a fourth embodiment; and

FIG. 20 is a diagram illustrating an exemplary hardware configuration of the feature calculation device according to the embodiments and modification examples.

### DETAILED DESCRIPTION

According to an embodiment, a feature calculation device includes a procurement controller, a first calculator, an extraction controller, a second calculator, and an integrating controller. The procurement controller obtains a plurality of strokes. The first calculator calculates, for each of the plurality of strokes, a stroke feature quantity related to a feature of the stroke. The extraction controller extracts, for each of the plurality of strokes, from the plurality of strokes, one or more neighboring strokes. The second calculator calculates, for each of the plurality of strokes, a combinational feature quantity based on a combination of the stroke and the one or more neighboring strokes. The integrating controller generates, for each of the plurality of strokes, an integrated feature quantity by integrating the stroke feature quantity and the combinational feature quantity.

Exemplary embodiments are described below in detail with reference to the accompanying drawings.

### First Embodiment

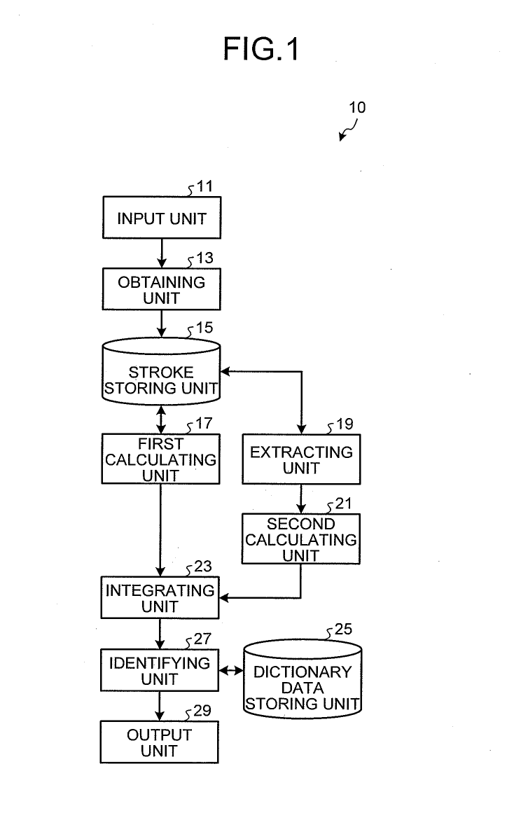

FIG. 1 is a configuration diagram illustrating an example of a feature calculation device 10 according to a first embodiment. As illustrated in FIG. 1, the feature calculation device 10 includes an input unit 11, an obtaining unit 13, a stroke storing unit 15, a first calculating unit 17, an extracting unit 19, a second calculating unit 21, an integrating unit 23, a dictionary data storing unit 25, an identifying unit 27, and an output unit 29.

The input unit 11 can be implemented using an input device such as a touch-sensitive panel, a touch pad, a mouse, or an electronic pen that enables handwritten input. The obtaining unit 13, the first calculating unit 17, the extracting unit 19, the second calculating unit 21, the integrating unit 23, the identifying unit 27, and the output unit 29 can be implemented by executing computer programs in a processing device such as a central processing unit (CPU), that is, can be implemented using software; or can be implemented using hardware such as an integrated circuit (IC); or can be implemented using a combination of software and hardware. The stroke storing unit 15 as well as the dictionary data storing unit 25 can be implemented using a memory device such as a hard disk drive (HDD), a solid state drive (SSD), a memory card, an optical disk, a read only memory (ROM), or a random access memory (RAM) in which information can be stored in a magnetic, optical, or electrical manner.

The input unit 11 sequentially receives input of strokes that are written by hand by a user, and inputs a plurality of strokes to the feature calculation device 10. Herein, for example, a plurality of strokes corresponds to handwritten data containing characters as well as non-characters (such as graphic forms).

In the first embodiment, it is assumed that the input unit 11 is a touch-sensitive panel, and that the user inputs a plurality of strokes by writing characters or graphic forms by hand on the touch-sensitive panel using a stylus pen or a finger. However, that is not the only possible case. Alternatively, for example, the input unit 11 can be implemented using a touch-pad, a mouse, or an electronic pen.

A stroke points to a stroke of a graphic form or a character written by hand by the user, and represents data of the locus from the time when a stylus pen or a finger makes contact with the input screen of the touch-sensitive panel until it is lifted from the input screen (i.e., the locus from a pen-down action to a pen-up action). For example, a stroke can be expressed as time-series coordinate values of contact points between a stylus pen or a finger and the input screen.

For example, when a plurality of strokes includes a first stroke to a third stroke, then the first stroke can be expressed as {(x(1,1), y(1,1)), (x(1,2), y(1,2)), . . . , (x(1, N(1)), y(1, N(1)))}; the second stroke can be expressed as {(x(2,1), y(2,1)), (x(2,2), y(2,2)), . . . , (x(2, N(2)), y(2, N(2)))}; and the third stroke can be expressed as {(x(3,1), y(3,1)), (x(3,2), y(3,2)), . . . , (x(3, N(3)), y(3, N(3)))}. Herein, N(i) represents the number of sampling points at the time of sampling the i-th stroke.

Meanwhile, the input unit 11 can assign, to each of a plurality of strokes, page information of the page in which the stroke is written (i.e., the page displayed on the display screen of a touch-sensitive panel); and then input the strokes to the feature calculation device 10. Herein, for example, the page information corresponds to page identification information that enables identification of pages.

The obtaining unit 13 obtains a plurality of strokes input from the input unit 11, and stores those strokes in the stroke storing unit 15.

For each stroke obtained by the obtaining unit 13 (i.e., for each stroke stored in the stroke storing unit 15), the first calculating unit 17 calculates a stroke feature quantity that is related to the feature quantities of that stroke. For example, when an application (not illustrated) installed in the feature calculation device 10 issues an integrated-feature-quantity calculation command, the first calculating unit 17 sequentially obtains a plurality of strokes stored in the stroke storing unit 15 and calculates the stroke feature quantity for each stroke. Meanwhile, in the case in which the strokes stored in the stroke storing unit 15 have the page information assigned thereto, then the application can issue an integrated-feature-quantity calculation command on a page-by-page basis.

The stroke feature quantity is, more specifically, the feature quantity related to the shape of a stroke. Examples of the stroke feature quantity include the length, the curvature sum, the main-component direction, the bounding rectangle area, the bounding rectangle length, the bounding rectangle aspect ratio, the start point/end point distance, the direction density histogram, and the number of folding points.

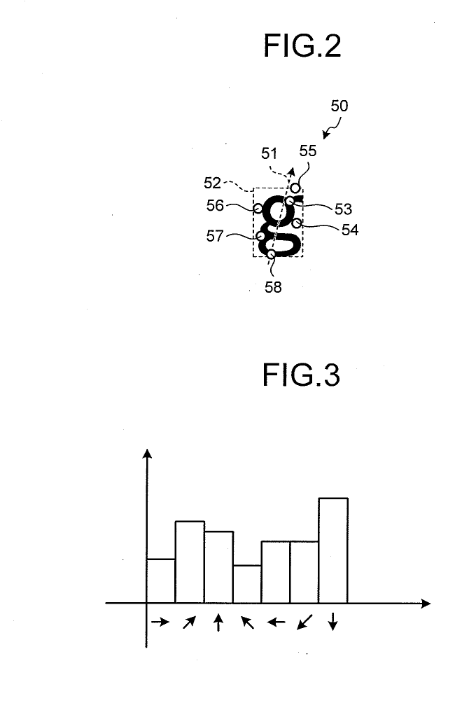

FIG. 2 is an explanatory diagram illustrating an example of the stroke feature quantity according to the first embodiment. With reference to FIG. 2, a stroke 50 is taken as an example, and the explanation is given about the stroke feature quantity of the stroke 50. Herein, the stroke 50 is assumed to be a single stroke.

Herein, in the case of the stroke 50, the length indicates the length of the stroke 50; the curvature sum indicates the sum of the curvatures of the stroke 50; the main-component direction indicates a direction 51; the bounding rectangle area indicates the area of a bounding rectangle 52; the bounding rectangle length indicates the length of the bounding rectangle 52; the bounding rectangle aspect ratio indicates the aspect ratio of the bounding rectangle 52; the start point/end point distance indicates the straight-line distance from a start point 53 to an end point 54; the number of folding points indicates four points from a folding point 55 to a folding point 58; and the direction density histogram indicates a histogram illustrated in FIG. 3.

In the first embodiment, it is assumed that, for each stroke obtained by the obtaining unit 13, the first calculating unit 17 calculates one or more feature quantities of the shape of that stroke; and treats a feature quantity vector, in which one or more calculated feature quantities are arranged, as the stroke feature quantity. However, that is not the only possible case.

Meanwhile, prior to calculating the stroke feature quantity, the first calculating unit 17 can perform sampling in such a way that the stroke is expressed using a certain number of coordinates. Alternatively, the first calculating unit 17 can partition a stroke and calculate the stroke feature quantity for each portion of the stroke. Herein, the partitioning of a stroke can be done using, for example, the number of folding points.

Moreover, the first calculating unit 17 can normalize the stroke feature quantities that have been calculated. For example, in the case in which the lengths are calculated as the stroke feature quantities, the first calculating unit 17 can normalize each stroke feature quantity by dividing the length of the corresponding stroke by the maximum value or the median value of the calculated lengths of a plurality of strokes. This normalization method can also be applied to the stroke feature quantities other than the lengths. Furthermore, for example, in the case in which the bounding rectangle areas are calculated as the stroke feature quantities, the first calculating unit 17 can calculate the sum of the calculated bounding rectangle areas of a plurality of strokes, and can use the calculated sum of the bounding rectangle areas in normalizing the bounding rectangle areas (the stroke feature quantities). This normalization method can be implemented to normalize not only the bounding rectangle areas but also the bounding rectangle lengths and the bounding rectangle aspect ratios.

For each stroke obtained by the obtaining unit 13 (i.e., for each stroke stored in the stroke storing unit 15); the extracting unit 19 extracts, from a plurality of strokes obtained by the obtaining unit 13 (i.e., from a plurality of strokes stored in the stroke storing unit 15), one or more neighboring strokes present around the stroke under consideration. For example, when the abovementioned application (not illustrated) issues an integrated-feature-quantity calculation command, the extracting unit 19 sequentially obtains a plurality of strokes stored in the stroke storing unit 15 and, for each obtained stroke, extracts one or more neighboring strokes.

Each set of one or more neighboring strokes includes, for example, one or more strokes, from among a plurality of strokes, present within a predetermined distance to a target stroke. Thus, the target stroke points to a stroke, from among a plurality of strokes, for which one or more neighboring strokes are extracted. Herein, the distance can be at least one of the spatial distance and the time-series distance.

For example, when the distance points to the spatial distance, the extracting unit 19 generates a window including the target stroke; and, as one or more neighboring strokes, extracts one or more strokes, from among a plurality of strokes, that are included in the window. Herein, if a stroke is only partially included in the window, the extracting unit 19 extracts that stroke.

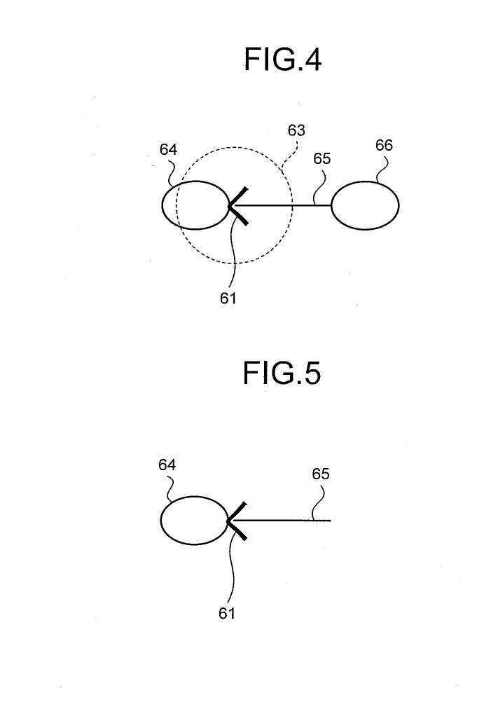

FIGS. 4 and 5 are explanatory diagrams illustrating an example of a window-based stroke extraction method according to the first embodiment. In FIG. 4 is illustrated a condition prior to the extraction of strokes, and in FIG. 5 is illustrated a condition after the extraction of strokes. In the example illustrated in FIG. 4, the extracting unit 19 generates a window 63 centered around a target stroke 61. Moreover, from among strokes 64 to 66, the strokes 64 and 65 are included in the window 63. Thus, as illustrated in FIG. 5, the extracting unit 19 extracts the strokes 64 and 65 as one or more neighboring strokes of the target stroke 61.

In the example illustrated in FIGS. 4 and 5, the window is illustrated to be circular in shape. However, that is not the only possible case. Alternatively, the window can have a rectangular shape, or can have a shape in accordance with the shape of the target stroke.

Herein, the extracting unit 19 can set the size of the window to a fixed size. Alternatively, the extracting unit 19 can set the size of the window based on the size of the target stroke, or based on the size of the page in which the target stroke is present (i.e., the size of the page in which the target stroke is written), or based on the total size of the bounding rectangles of a plurality of strokes.

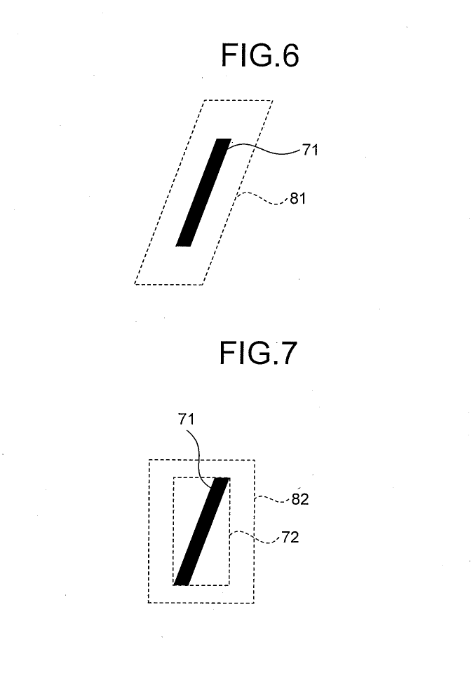

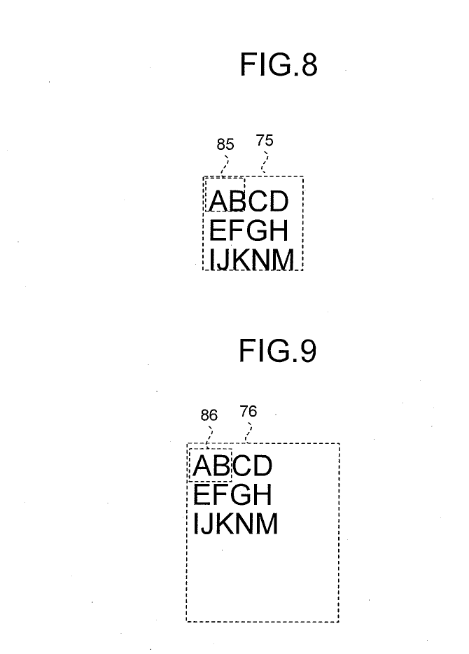

FIGS. 6 to 9 are explanatory diagrams illustrating examples of the shape and the size of the window according to the first embodiment. For example, as illustrated in FIG. 6, the extracting unit 19 can set, as the window, a shape 81 that is formed by expanding each coordinate of a stroke 71 by N1 times to the outside of the stroke 71. Alternatively, as illustrated in FIG. 7, the extracting unit 19 can set, as the window, a shape 82 that is formed by expanding a bounding rectangle 72 of the stroke 71 by N2 times or the shape 82 that is formed by means of pixel expansion by N3 times. Still alternatively, as illustrated in FIG. 8, the extracting unit 19 can set, as the window, a shape 85 that is formed by reducing a sum 75 of the bounding rectangle areas of a plurality of strokes, which is obtained by the obtaining unit 13, by N4 times. Still alternatively, the extracting unit 19 can set, as the window, a shape 86 that is formed by reducing the page size of a page 76, in which a plurality of strokes are written, by N4 times. In this case, it is assumed that the page size of the page 76 is stored in advance in the feature calculation device 10.

Meanwhile, the extracting unit 19 can generate such a window that the central coordinates of the window match with the center of gravity point of the target stroke, or match with the start point of the target stroke, or match with the end point of the target stroke, or match with the center point of the bounding rectangle of the target stroke.

Alternatively, the extracting unit 19 can partition the neighborhood space of the target stroke into a plurality of partitioned spaces, and generate a window in each partitioned space. Still alternatively, the extracting unit 19 can generate a window at each set of coordinates constituting the target stroke.

Still alternatively, with respect to the target stroke, the extracting unit 19 can generate a plurality of windows having different sizes.

Meanwhile, when the distance points to the spatial distance, the extracting unit 19 can calculate the spatial distance between the target stroke and each of a plurality of strokes. Then, the extracting unit 19 can extract, as one or more neighboring strokes, N number of strokes from among a plurality of strokes in order of increasing spatial distance to the target stroke. In this case, examples of the spatial distance include, for example, the gravity point distance between strokes or the end point distance between strokes.

In contrast, for example, when the distance points to the time-series distance; the extracting unit 19 can extract, as one or more neighboring strokes, such strokes which, from among a plurality of strokes, are input to the feature calculation device 10 within a certain number of seconds with reference to the target stroke.

Moreover, for example, when the distance points to the time-series distance, the extracting unit 19 can calculate the time-series distance between the target stroke and each of a plurality of strokes. Then, the extracting unit 19 can extract, as one or more neighboring strokes, N number of strokes from among a plurality of strokes in order of increasing time-series distance to the target stroke.

Meanwhile, it is also possible that, for example, the extracting unit 19 groups a plurality of strokes based on an area standard, a spatial distance standard, or a time-series distance standard; and, as one or more neighboring strokes, extracts the strokes belonging to the group that also includes the target stroke.

Moreover, it is also possible that the extracting unit 19 extracts one or more neighboring strokes by combining the extraction methods described above. For example, once strokes are extracted from a plurality of strokes using the time-series distances, the extracting unit 19 can further extract strokes from the already-extracted strokes using the spatial distances and treat the newly-extracted strokes as one or more neighboring strokes. Alternatively, once strokes are extracted from a plurality of strokes using the spatial distances, the extracting unit 19 can further extract strokes from the already-extracted strokes using the time-series distances and treat the newly-extracted strokes as one or more neighboring strokes. Still alternatively, the extracting unit 19 can make combined use of the time-series distances and the spatial distances, and treat the strokes extracted using the time-series distances as well as the strokes extracted using the spatial distances as one or more neighboring strokes.

Meanwhile, with respect to the strokes extracted by implementing any of the extraction methods described above, the extracting unit 19 can perform filtering and treat the post-filtering strokes as one or more neighboring strokes.

For example, as one or more neighboring strokes, the extracting unit 19 can extract one or more strokes, from among a plurality of strokes, that are within a predetermined distance to the target stroke and that have the degree of shape similarity with respect to the target stroke equal to or greater than a threshold value. That is, the extracting unit 19 can extract, from among a plurality of strokes, the strokes that are within a predetermined distance to the target stroke; performs filtering of the extracted strokes using the degree of shape similarity with respect to the target stroke; and treats the post-filtering strokes as one or more neighboring strokes.

The degree of shape similarity between two strokes can be at least one of the following: the degree of similarity in the lengths of the two strokes, the degree of similarity in the main-component directions of the two strokes, the degree of similarity in the curvature sums of the two strokes, the degree of similarity in the bounding rectangle areas of the two strokes, the degree of similarity in the bounding rectangle lengths of the two strokes, the degree of similarity in the number of folding points of the two strokes, and the degree of similarity in the direction density histograms of the two strokes.

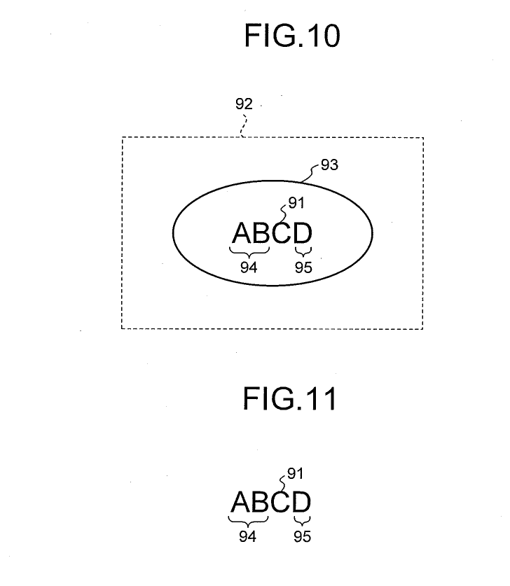

FIGS. 10 and 11 are explanatory diagrams illustrating an example of the filtering method according to the first embodiment. In FIG. 10 is illustrated a condition prior to the filtering, and in FIG. 11 is illustrated a condition after the filtering. In the example illustrated in FIG. 10, the extracting unit 19 generates a window 92 around a target stroke 91 in such a way that strokes 93 to 95 are included in the window 92. Herein, the target stroke 91 and the strokes 94 and 95 are character strokes constituting characters. In contrast, the stroke 93 is a non-character stroke constituting a non-character such as a graphic form. Herein, for the purpose of illustration, regarding the stroke 94 as well as the stroke 95, the reference numeral is assigned not to a single character stroke but to a plurality of character strokes. However, the degree of similarity with respect to the target stroke 91 is calculated for each stroke included in the stroke 94 and each stroke included in the stroke 95.

Typically, there is a higher degree of similarity between two character strokes, while there is a lower degree of similarity between a character stroke and a non-character stroke. Hence, in this case, as illustrated in FIG. 11, the extracting unit 19 performs filtering and extracts, as one or more neighboring strokes of the target stroke 91, the strokes 94 and 95 that have the degree of similarity with the target stroke 91 equal to or greater than a threshold value.

In this way, if filtering is performed using the degree of shape similarity with respect to the target stroke and if it results in the extraction of one or more neighboring strokes, then it becomes easier to prevent a situation in which the one or more neighboring strokes include strokes belonging to a class different than the class to which the target stroke belongs. Herein, a class can be at least one of the following: characters, figures, tables, pictures (for example, rough sketches), and the like. Thus, as long as characters and non-characters can be distinguished in a broad manner, it serves the purpose.

For each stroke obtained by the obtaining unit 13 (i.e., for each stroke stored in the stroke storing unit 15), the second calculating unit 21 calculates a combinational feature quantity that is related to the feature quantity of the combination of the stroke under consideration (the target stroke) and the one or more neighboring strokes that are extracted by the extracting unit 19.

The combinational feature quantity includes a first-type feature quantity that indicates the relationship between the target stroke and at least one of the one or more neighboring strokes. Moreover, the combinational feature quantity includes a second-type feature quantity that is obtained using a sum value representing the sum of the feature quantity related to the shape of the target stroke and the feature quantity related to the shape of each of the one or more neighboring strokes.

The first-type feature quantity is at least one of the following two: the degree of shape similarity between the target stroke and at least one of the one or more neighboring strokes; and a specific value that enables identification of the positional relationship between the target stroke and at least one of the one or more neighboring strokes.

Herein, the degree of shape similarity between the target stroke and at least one of the one or more neighboring strokes indicates, for example, the degree of similarity in at least one of the lengths, the curvature sums, the main-component directions, the bounding rectangle areas, the bounding rectangle lengths, the bounding rectangle aspect ratios, the start point/end point distances, the direction density histograms, and the number of folding points. Thus, for example, the degree pf shape similarity can be regarded as the degree of similarity between the stroke feature quantity of the target stroke and the stroke feature quantity of at least one of the one or more neighboring strokes.

For example, the second calculating unit 21 compares the stroke feature quantity of the target stroke with the stroke feature quantity of each of the one or more neighboring strokes by means of division or subtraction, and calculates one or more degrees of shape similarity.

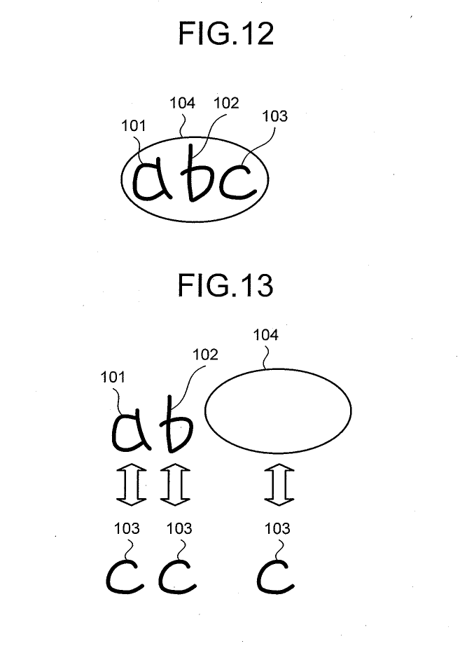

FIGS. 12 and 13 are explanatory diagrams illustrating an example of the calculation method for calculating the degrees of shape similarity according to the first embodiment. As illustrated in FIG. 12, it is assumed that the neighboring strokes of a target stroke 103 are neighboring strokes 101, 102, and 104. In this case, as illustrated in FIG. 13, the second calculating unit 21 compares the stroke feature quantity of the target stroke 103 with the stroke feature quantity of each of the neighboring strokes 101, 102, and 104; and calculates the degree of shape similarity between the stroke feature quantity of the target stroke 103 and the stroke feature quantity of each of the neighboring strokes 101, 102, and 104.

Meanwhile, the specific value is, for example, at least one of the following: the overlapping percentage of the bounding rectangles of the target stroke and at least one of the one or more neighboring strokes; the gravity point distance between those two strokes; the direction of the gravity point distance between those two strokes; the end point distance between those two strokes; the direction of the end point distance between those two strokes; and the number of points of intersection between those two strokes.

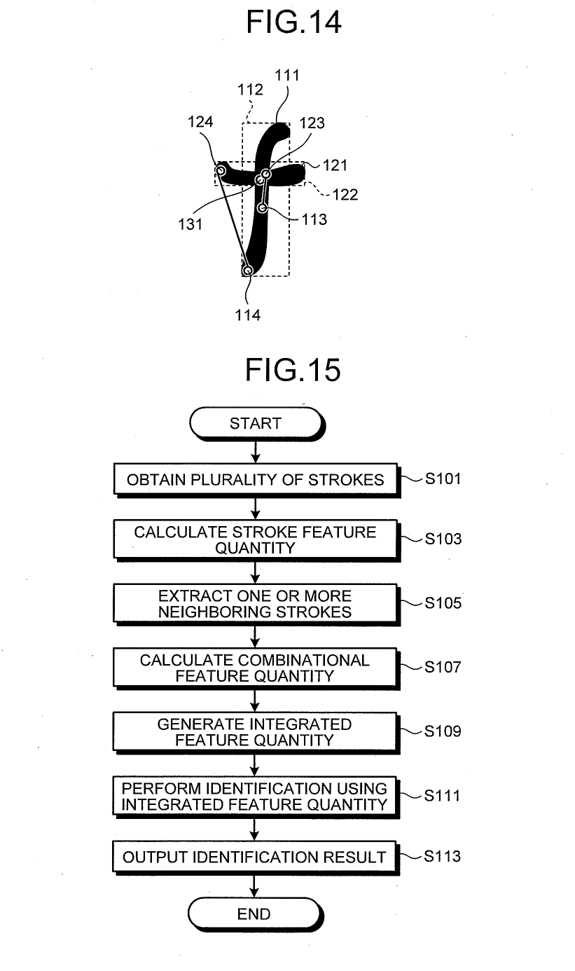

FIG. 14 is an explanatory diagram illustrating an example of the specific value according to the first embodiment. With reference to FIG. 14, a target stroke 111 and a neighboring stroke 121 are taken as an example, and the explanation is given about the specific value between the target stroke 111 and the neighboring stroke 121.

In the case of the target stroke 111 and the neighboring stroke 121, the overlapping percentage of the bounding rectangles represents the ratio of the area of the overlapping portion between a bounding rectangle 112 of the target stroke 111 and a bounding rectangle 122 of the neighboring stroke 121 with respect to the sum of the area of the bounding rectangle 112 and the area of the bounding rectangle 122. Moreover, in the case of the target stroke 111 and the neighboring stroke 121, the gravity point distance is the straight-line distance from a gravity point 113 of the target stroke 111 and a gravity point 123 of the neighboring stroke 121; and the direction of the gravity point distance is the direction of that straight-line distance. Furthermore, in the case of the target stroke 111 and the neighboring stroke 121, the end point distance is the straight-line distance from an end point 114 of the target stroke 111 and an end point 124 of the neighboring stroke 121; and the direction of the end point distance is the direction of that straight-line distance. Moreover, in the case of the target stroke 111 and the neighboring stroke 121, the number of points of intersection indicates the number of a point of intersection 131, that is, indicates a single point.

In the first embodiment, in the case of calculating the first-type feature quantity of the target stroke, the second calculating unit 21 calculates, for each neighboring stroke, a set that includes the degree of shape similarity with respect to the target stroke and includes the specific value; and treats the calculated sets of the degree of shape similarity and the specific value for all neighboring strokes as the first-type feature quantity. However, the first-type feature quantity is not limited to this case.

Alternatively, for example, of the sets of the degree of shape similarity and the specific value for all neighboring strokes, either a certain number of sets can be treated as the first-type feature quantity, or the set having the maximum value can be treated as the first-type feature quantity, or the set having the minimum value can be treated as the first-type feature quantity, or the set having the median value can be treated as the first-type feature quantity, or the sum of the sets for all neighboring strokes can be treated as the first-type feature quantity.

Meanwhile, in the case in which the extracting unit 19 generates a plurality of windows with respect to the target stroke and extracts one or more neighboring strokes for each window, there are times when a plurality of sets of the degree of shape similarity and the specific value is extracted for a single neighboring stroke. In that case, the second calculating unit 21 can use the average value of a plurality of sets, or can firstly weight each of a plurality of sets and then use the average value of the weighted sets. For example, if one or more neighboring strokes are generated in each of a plurality of windows having different sizes; then, by assigning a greater weight to a neighboring stroke extracted in a smaller window, the second calculating unit 21 can obtain the sets of the degree of shape similarity and the specific value with emphasis on the neighboring strokes positioned close to the target stroke.

The second-type feature quantity is, for example, at least one of the following: the ratio of the sum of the length of the target stroke and the length of each of the one or more neighboring strokes with respect to the bounding rectangle length of the combination; the sum value of the direction density histograms of the target stroke and at least one of the one or more neighboring strokes; and the ratio of the sum of the bounding rectangle area of the target stroke and the bounding rectangle area of each of the one or more neighboring strokes with respect to the bounding rectangle area of the combination.

In the case in which the extracting unit 19 generates a plurality of windows with respect to the target stroke and extracts one or more neighboring strokes for each window, there are times when a plurality of lengths, a plurality of direction density histograms, or a plurality bounding rectangle areas is calculated. In that case, the second calculating unit 21 can weight each of a plurality of lengths, can weight each of a plurality of direction density histograms, or can weight each of a plurality bounding rectangle areas; and use the average value of the weighted lengths, or use the average value of the weighted direction density histograms, or use the average value of the weighted bounding rectangle areas. For example, if one or more neighboring strokes are generated in each of a plurality of windows having different sizes; then, by assigning a greater weight to a neighboring stroke extracted in a smaller window, the second calculating unit 21 can obtain the lengths, the direction density histograms, or the bounding rectangle areas with emphasis on the neighboring strokes positioned close to the target stroke.

In the first embodiment, it is assumed that, for each target stroke, the second calculating unit 21 treats a feature quantity vector, in which the first-type feature quantity that is calculated and the second-type feature quantity that is calculated are arranged, as the combinational feature quantity. However, that is not the only possible case.

For each stroke obtained by the obtaining unit 13 (i.e., for each stroke stored in the stroke storing unit 15), the integrating unit 23 generates an integrated feature quantity by integrating the stroke feature quantity calculated by the first calculating unit 17 with the combinational feature quantity calculated by the second calculating unit 21.

In the first embodiment, it is assumed that the integrating unit 23 treats a feature quantity vector, in which the stroke feature quantities and the combinational feature quantities are arranged, as the integrated feature quantity. However, that is not the only possible case.

The dictionary data storing unit 25 is used to store dictionary data, which represents a learning result of the learning done using the integrated feature quantities of a plurality of sample strokes and using correct-answer data for each class and which indicates the class to which belongs the integrated feature quantity of each of a plurality of sample strokes. As described above, a class can be at least one of the following: characters, figures, tables, and pictures, and the like. Thus, as long as characters and non-characters can be distinguished in a broad manner, it serves the purpose.

For each stroke obtained by the obtaining unit 13 (i.e., for each stroke stored in the stroke storing unit 15), the identifying unit 27 identifies the class of that stroke by referring to the integrated feature quantity obtained by the integrating unit 23. More particularly, the identifying unit 27 reads the dictionary data from the dictionary data storing unit 25 and identifies the class of each stroke by referring to the dictionary data and referring to the integrated feature quantity obtained by the integrating unit 23. Herein, the identifying unit 27 can be implemented using a classifier such as a neural network (a multi-layer perceptron), a support vector machine, or an AdaBoost classifier.

The output unit 29 outputs the identification result of the identifying unit 27, that is, outputs the class to which a stroke belongs.

FIG. 15 is a flowchart for explaining an exemplary sequence of operations during an identification operation performed in the feature calculation device 10 according to the first embodiment.

Firstly, the obtaining unit 13 obtains a plurality of strokes input from the input unit 11, and stores the strokes in the stroke storing unit 15 (Step S101).

Then, for each stroke stored in the stroke storing unit 15, the first calculating unit 17 calculates the stroke feature quantity that is related to a feature quantity of that stroke (Step S103).

Subsequently, for each stroke stored in the stroke storing unit 15, the extracting unit 19 extracts, from a plurality of strokes stored in the stroke storing unit 15, one or more neighboring strokes present around the stroke under consideration (Step S105).

Then, for each stroke stored in the stroke storing unit 15, the second calculating unit 21 calculates the combinational feature quantity that is related to the feature quantity of the combination of the stroke under consideration and the one or more neighboring strokes that are extracted by the extracting unit 19 (Step S107).

Subsequently, for each stroke stored in the stroke storing unit 15, the integrating unit 23 generates an integrated feature quantity by integrating the stroke feature quantity calculated by the first calculating unit 17 with the combinational feature quantity calculated by the second calculating unit 21 (Step S109).

Then, for each stroke stored in the stroke storing unit 15, the identifying unit 27 identifies the class of that stroke by referring to the integrated feature quantity obtained by the integrating unit 23 (Step S111).

Subsequently, the output unit 29 outputs the identification result of the identifying unit 27, that is, outputs the class to which the stroke under consideration belongs (Step S113).

In this way, in the first embodiment, the integrated feature quantity, which is related to the stroke feature quantity related to a feature of the stroke under consideration and the combinational feature quantity of a combination of that stroke and one or more neighboring strokes present around that stroke, is calculated as the feature quantity of that stroke.

Herein, although the combinational feature quantity represents the feature quantity peculiar to the stroke under consideration, it is calculated using not only the features of the stroke under consideration but also the features of one or more neighboring strokes. Hence, the combinational feature quantity can be used as the feature quantity related to the class to which the stroke under consideration belongs.

For that reason, according to the first embodiment, the feature quantity peculiar to the stroke under consideration can be used as the feature quantity related to the class to which that stroke belongs.

Moreover, according to the first embodiment, the class to which the stroke under consideration belongs is identified using the integrated feature quantity, that is, using the feature quantity peculiar to that stroke. Hence, it becomes possible to enhance the accuracy in class identification.

In this way, if the feature calculation device 10 according to the first embodiment is applied to a formatting device that identifies whether a handwritten graphic form that is written by a user by hand represents characters, or a graphic form, or a table, or a picture, and accordingly formats the handwritten graphic form; then it becomes possible to provide the formatting device having enhanced identification accuracy.

### Second Embodiment

In a second embodiment, the explanation is given about an example in which the learning is done using the integrated feature quantity. The following explanation is given with the focus on the differences with the first embodiment, and the constituent elements having identical functions to the first embodiment are referred to by the same names and the same reference numerals. Hence, the explanation of those constituent elements is not repeated.

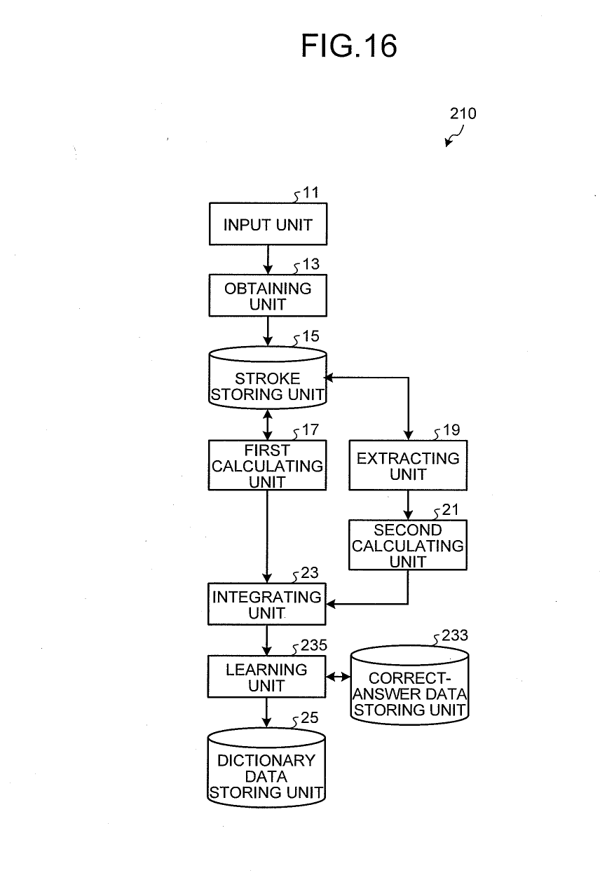

FIG. 16 is a configuration diagram illustrating an example of a feature calculation device 210 according to the second embodiment. As illustrated in FIG. 16, the feature calculation device 210 according to the second embodiment differs from the first embodiment in the way that the identifying unit 27 and the output unit 29 are not disposed, but a correct-answer data storing unit 233 and a learning unit 235 are disposed.

The correct-answer data storing unit 233 is used to store correct-answer data on a class-by-class basis.

For each stroke obtained by the obtaining unit 13 (i.e., for each stroke stored in the stroke storing unit 15), the learning unit 235 refers to the integrated feature quantity obtained by the integrating unit 23 and learns about the class to which that stroke belongs. More particularly, the learning unit 235 reads the correct-answer data from the correct-answer data storing unit 233, refers to the correct-answer data and to the integrated feature quantity obtained by the integrating unit 23, learns about the class to which the stroke under consideration belongs, and stores the learning result in the dictionary data storing unit 25.

As far as the learning method implemented by the learning unit 235 is concerned, it is possible to implement a known learning method. For example, if a neural network is used as the classifier that makes use of the learning result (the dictionary data); then the learning unit 235 can perform the learning according to the error back propagation method.

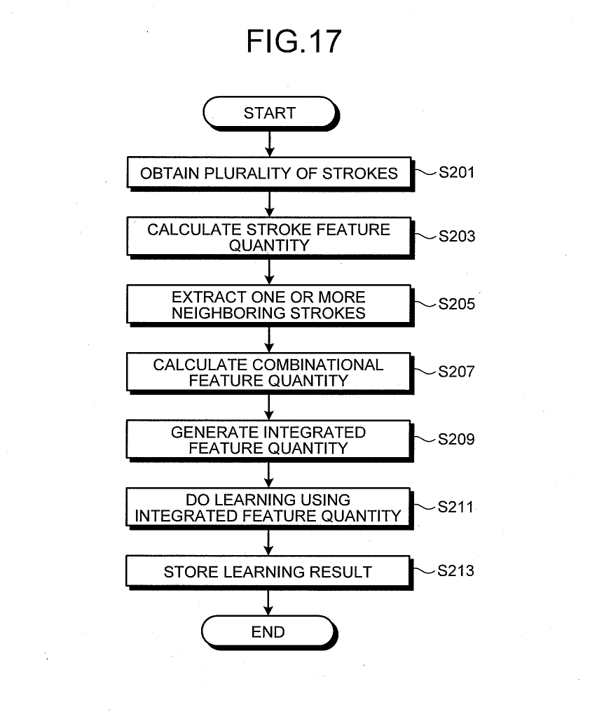

FIG. 17 is a flowchart for explaining a sequence of operations during a learning operation performed in the feature calculation device 210 according to the second embodiment.

Firstly, the operations performed from Step S201 to Step S209 are identical to the operations performed from Step S101 to Step S109 illustrated in the flowchart in FIG. 15.

Then, for each stroke stored in the stroke storing unit 15, the learning unit 235 refers to the integrated feature quantity obtained by the integrating unit 23 and learns about the class of the stroke under consideration (Step S211), and stores the learning result in the dictionary data storing unit 25 (Step S213).

Thus, according to the second embodiment, learning about the class to which the stroke under consideration belongs is done using the integrated feature quantity, that is, the feature quantity peculiar to that stroke. Hence, it becomes possible to enhance the accuracy in the learning about the classes.

### Third Embodiment

In a third embodiment, the explanation is given about an example in which, while extracting neighboring strokes, document information is also extracted and is included in the combinational feature quantity. The following explanation is given with the focus on the differences with the first embodiment, and the constituent elements having identical functions to the first embodiment are referred to by the same names and the same reference numerals. Hence, the explanation of those constituent elements is not repeated.

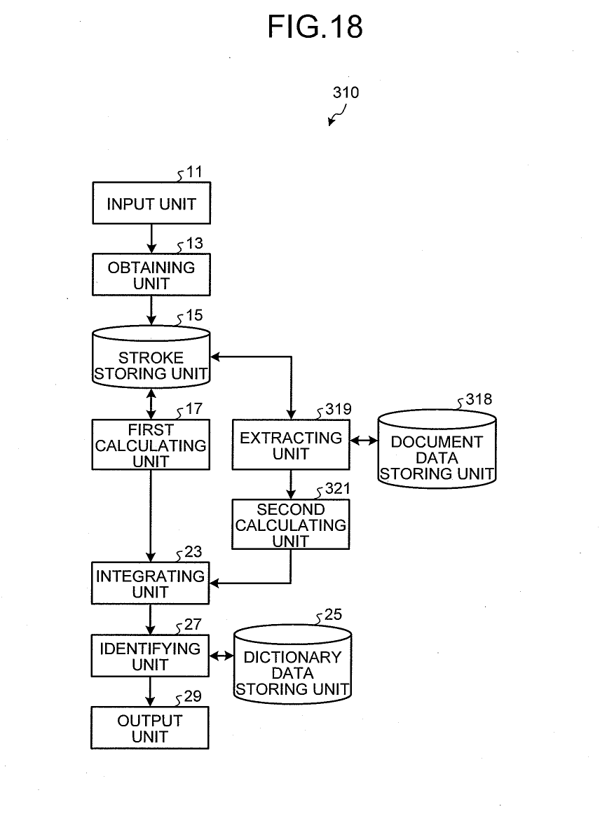

FIG. 18 is a configuration diagram illustrating an example of a feature calculation device 310 according to the third embodiment. As illustrated in FIG. 18, the feature calculation device 310 according to the third embodiment differs from the first embodiment in the way that a document data storing unit 318, an extracting unit 319, and a second calculating unit 321 are disposed.

Meanwhile, in the third embodiment, it is assumed that the user inputs strokes not on a blank page but on a page having document information written therein.

The document data storing unit 318 is used to store document data that represents document information written in the pages and contains, for example, character information, figure information, and layout information. Meanwhile, when the document data is in the form of image data, the document information can be restored using an optical character reader (OCR). Moreover, the document data can be in the form of some other contents such as moving-image data.

For each stroke obtained by the obtaining unit 13 (i.e., for each stroke stored in the stroke storing unit 15), the extracting unit 319 extracts, from a plurality of strokes, one or more neighboring strokes that are present around the stroke under consideration, as well as extracts document information present around the stroke under consideration.

For each stroke obtained by the obtaining unit 13 (i.e., for each stroke stored in the stroke storing unit 15), the second calculating unit 321 calculates a combinational feature quantity that is related to the feature quantity of the combination of the stroke under consideration (the target stroke), the one or more neighboring strokes that are extracted by the extracting unit 319, and the document information that is extracted by the extracting unit 319.

Typically, in a situation of adding information in handwriting to a document, non-character strokes such as signs (encircling, underscoring, leader lines, carets, or strike-through) for indicating a highlighted portion or a corrected portion are written by hand in an overlaying manner on the information of the document; and character strokes such as comments and annotations are written by hand in the blank portion in an easy-to-read manner. For that reason, the identifying unit 27 can be configured to refer not only to the identification result using the dictionary data but also to the abovementioned details (such as whether a stroke is present in a character area or in a blank portion), and to identify the class to which a stroke belongs.

Thus, if the feature calculation device 310 according to third embodiment is applied to, for example, an information processing device that identifies strokes on a meaning-by-meaning basis, such as according to highlighted portions or corrected portions, and reflects those strokes in the display; then it becomes possible to provide the information processing device having enhanced identification accuracy.

### Fourth Embodiment

In a fourth embodiment, the explanation is given about an example in which, while extracting neighboring strokes, document information is also extracted and is included in the combinational feature quantity. The following explanation is given with the focus on the differences with the second embodiment, and the constituent elements having identical functions to the second embodiment are referred to by the same names and the same reference numerals. Hence, the explanation of those constituent elements is not repeated.

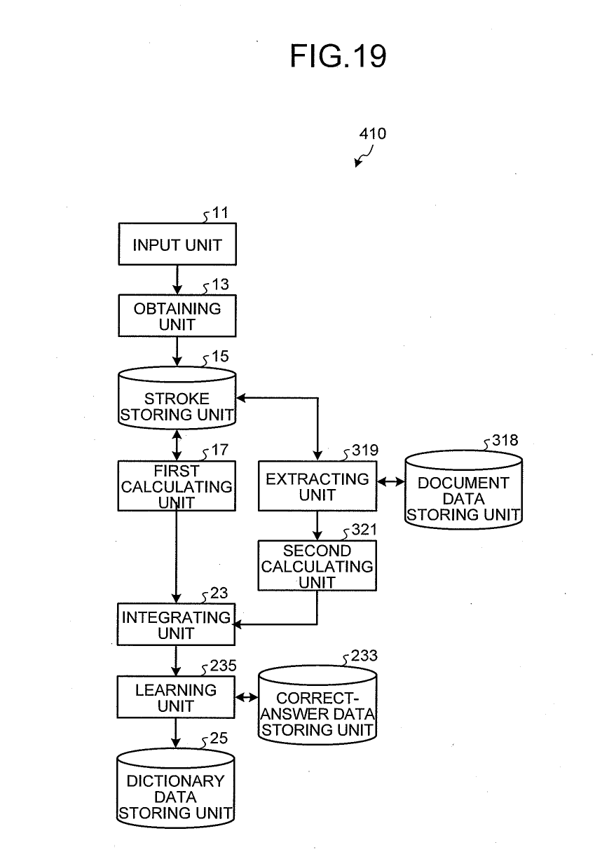

FIG. 19 is a configuration diagram illustrating an example of a feature calculation device 410 according to the fourth embodiment. As illustrated in FIG. 19, the feature calculation device 410 according to the fourth embodiment differs from the second embodiment in the way that the document data storing unit 318, the extracting unit 319, and the second calculating unit 321 are disposed.

Herein, the document data storing unit 318, the extracting unit 319, and the second calculating unit 321 are identical to the explanation given in the third embodiment. Hence, that explanation is not repeated.

### Modification Examples

In the embodiments described above, the explanation is given about an example in which the feature calculation device includes various storing units such as a stroke storing unit and a dictionary data storing unit. However, that is not the only possible case. Alternatively, for example, the storing units can be installed on the outside of the feature calculation device such as on the cloud.

Moreover, it is also possible to arbitrarily combine the embodiments described above. For example, it is possible to combine the first embodiment and the second embodiment, or it is possible to combine the third embodiment and the fourth embodiment.

Hardware Configuration

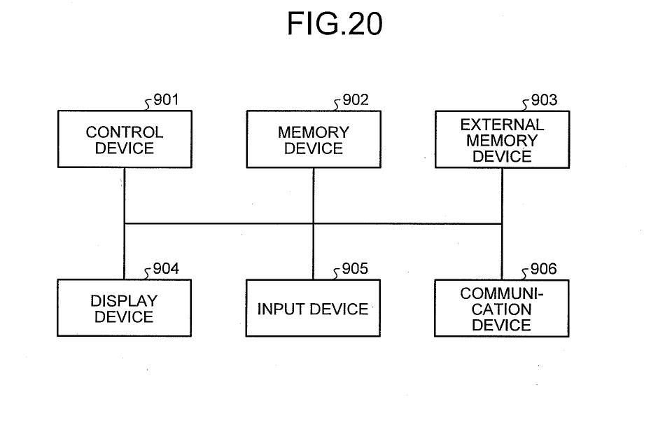

FIG. 20 is a diagram illustrating an exemplary hardware configuration of the feature calculation device according to the embodiments and the modification examples described above. The feature calculation device according to the embodiments and the modification examples described above has the hardware configuration of a commonplace computer that includes a control device 901 such as a central processing unit (CPU), a memory device 902 such as a read only memory (ROM) or a random access memory (RAM), an external memory device 903 such as a hard disk drive (HDD), a display device 904 such as a display, an input device 905 such as a keyboard or a mouse, and a communication device 906 such as a communication interface.

Meanwhile, computer programs executed in the feature calculation device according to the embodiments and the modification examples described above are recorded in the form of installable or executable files in a computer-readable recording medium such as a compact disk read only memory (CD-ROM), a compact disk readable (CD-R), a memory card, a digital versatile disk (DVD), or a flexible disk (FD).

Alternatively, the computer programs executed in the feature calculation device according to the embodiments and the modification examples described above can be saved as downloadable files on a computer connected to the Internet or can be made available for distribution through a network such as the Internet. Still alternatively, the computer programs executed in the feature calculation device according to the embodiments and the modification examples described above can be stored in advance in a ROM or the like.

The computer programs executed in the feature calculation device according to the embodiments and the modification examples described above contain modules for implementing each of the abovementioned constituent elements in a computer. In practice, for example, a CPU loads the computer programs from an HDD and runs them so that the computer programs are loaded in a RAM. As a result, the module for each constituent element is generated in the computer.

For example, unless contrary to the nature thereof, the steps of the flowcharts according to the embodiments described above can have a different execution sequence, can be executed in plurality at the same time, or can be executed in a different sequence every time.

In this way, according to the embodiments and the modification examples described above, a feature quantity peculiar to the stroke under consideration can be used as the feature quantity related to the class to which that stroke belongs.

For example, in the past, the relationships used to be written based on probability propagation (HMM) or strokes used as structures. For example, a method of using a feature quantity (particularly using the shape) peculiar to a single stroke (reference: Distinguishing Text from Graphics in On-line Handwritten Ink, bishop et al.) is also one of the examples. In contrast, herein, in addition to using a feature quantity peculiar to the stroke under consideration, it also becomes possible to make use of the feature quantity involving the strokes present around the stroke under consideration. Hence, it becomes possible to achieve a greater degree of distinguishability. Besides the relationships among strokes can be written in a continuous manner, and can be used in the identification of those strokes.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A feature calculation device comprising:
a procurement controller configured to obtain a plurality of strokes;
a first calculator configured to calculate, for each of the plurality of strokes, a stroke feature quantity related to a feature of the stroke;
an extraction controller configured to extract, for each of the plurality of strokes, from the plurality of strokes, one or more neighboring strokes;
a second calculator configured to calculate, for each of the plurality of strokes, a combinational feature quantity based on a combination of the stroke and the one or more neighboring strokes; and
an integrating controller configured to generate, for each of the plurality of strokes, an integrated feature quantity by integrating the stroke feature quantity and the combinational feature quantity.

2. The device according to claim 1, wherein the combinational feature quantity comprises a first-type feature quantity indicative of a relationship between the stroke and at least one of the one or more neighboring strokes.

3. The device according to claim 2, wherein the first-type feature quantity comprises at least one of a degree of shape similarity between the stroke and at least one of the one or more neighboring strokes and a specific value which enables identification of a positional relationship between the stroke and at least one of the one or more neighboring strokes.

4. The device according to claim 3, wherein the degree of shape similarity comprises a degree of similarity in at least one of lengths, curvature sums, main-component directions, bounding rectangle areas, bounding rectangle lengths, boundary rectangle aspect ratios, start point/end point distances, direction density histograms, and number of folding points between the stroke and at least one of the one or more neighboring strokes.

5. The device according to claim 3, wherein the specific value comprises at least one of an overlapping percentage of bounding rectangles, a gravity point distance, a direction of the gravity point distance, an end point distance, a direction of the end point distance, and a number of points of intersection between the stroke and at least one of the one or more neighboring strokes.

6. The device according to claim 1, wherein the combinational feature quantity comprises a second-type feature quantity which is obtained using a sum value representing a sum of a feature quantity related to the shape of the stroke and a feature quantity related to the shape of each of the one or more neighboring strokes.

7. The device according to claim 6, wherein the second-type feature quantity comprise at least one of a ratio of the sum of the length of the stroke and the length of each of the one or more neighboring strokes with respect to the bounding rectangle length of the combination, a sum value of direction density histograms of the stroke and the one or more neighboring strokes, and a ratio of the sum of a bounding rectangle area of the stroke and a bounding rectangle area of each of the one or more neighboring strokes with respect to a bounding rectangle area of the combination.

8. The device according to claim 1, wherein the one or more neighboring strokes comprise one or more strokes, from among the plurality of strokes, present within a first distance to the stroke.

9. The device according to claim 8, wherein the first distance comprises at least one of a spatial distance and a time-series distance.

10. The device according to claim 9, wherein, when the first distance comprises the spatial distance, the extraction controller generates a window including the stroke, and, as the one or more neighboring strokes, extracts one or more strokes, from among the plurality of strokes in the window.

11. The device according to claim 10, wherein the extraction controller determines a size of the window based on a size of the stroke, based on a size of a page in which the stroke is present, or based on a total size of bounding rectangles of the plurality of strokes.

12. The device according to claim 1, wherein the extraction controller groups the plurality of strokes based on an area standard, a spatial distance standard, or a time-series distance standard, and extracts, as the one or more neighboring strokes, strokes belonging to a group that includes the stroke.

13. The device according to claim 1, wherein, from among the plurality of strokes, the one or more neighboring strokes comprises one or more strokes which are within a first distance to the stroke and which have a degree of shape similarity with respect to the stroke equal to or greater than a threshold value.

14. The device according to claim 1, wherein the stroke feature quantity comprises a feature quantity related to the shape of the stroke.

15. The device according to claim 1, further comprising an identifying controller configure to, for each of the plurality of strokes, refer to the integrated feature quantity and identify a class to which the stroke belongs.

16. The device according to claim 15, wherein the class comprises at least one of characters, figures, tables, and pictures.

17. The device according to claim 1, further comprising a learning controller configured to, for each of the plurality of strokes, refer to the integrated feature quantity and learn about a class to which the stroke belongs.

18. The device according to claim 1, wherein
for each of the plurality of strokes, the extraction controller extracts, from the plurality of strokes, one or more neighboring strokes as well as extracts document information present around the stroke, and
the combinational feature quantity comprises a feature quantity related to a feature of a combination of the stroke, the one or more neighboring strokes, and the document information.

19. A feature calculation method comprising:
obtaining a plurality of strokes;
calculating, for each of the plurality of strokes, a stroke feature quantity related to a feature of the stroke;
extracting, for each of the plurality of strokes, one or more neighboring strokes, from the plurality of strokes;
calculating, for each of the plurality of strokes, a combinational feature quantity based on a combination of the stroke and the one or more neighboring strokes; and
integrating, for each of the plurality of strokes, the stroke feature quantity and the combinational feature quantity to generate an integrated feature quantity.

20. A computer program product comprising a non-transitory computer-readable medium containing a computer program that causes a computer to execute:
obtaining a plurality of strokes;
calculating, for each of the plurality of strokes, a stroke feature quantity related to a feature of the stroke;
extracting, for each of the plurality of strokes, one or more neighboring strokes, from the plurality of strokes;
calculating, for each of the plurality of strokes, a combinational feature quantity based on a combination of the stroke and the one or more neighboring strokes; and
integrating, for each of the plurality of strokes, the stroke feature quantity and the combinational feature quantity to generate an integrated feature quantity.
